(19) United States
(12) Patent Application Publication
(10) Pub. No.: US 2025/0330331 A1
(43) Pub. Date: Oct. 23, 2025

(54) SECURITY FOR READ COMMANDS

(71) Applicant: Micron Technology, Inc., Boise, ID (US)

(72) Inventor: Zhou Zhou, Shanghai (CN)

(21) Appl. No.: 19/172,345

(22) Filed: Apr. 7, 2025

Related U.S. Application Data
(60) Provisional application No. 63/635,983, filed on Apr. 18, 2024.

(51) Int. Cl. H04L 9/32

(52) U.S. Cl. CPC H04L 9/3242

(57) ABSTRACT

Methods, systems, and devices for security for read commands are described. The memory system receive a read command to read data from a read protected memory block (RPMB) region. The read command may include a first message authenticated code (MAC) key. In some cases, the memory system may authenticate the read command using the first MAC key and retrieving the data from the RPMB region. The memory system may transmit the data after retrieving the data from the RPMB region. In some cases, the memory system may determine whether a read protect flag associated with a logical unit identified by the read command indicates that reading of data stored in the logical unit is permitted. The memory system may read the data based on determining that the read protect flag permits reading the data.

### CROSS REFERENCE

The present Application for Patent claims priority to U.S. Patent Application No. 63/635,983 by Zhou, entitled “SECURITY FOR READ COMMANDS,” filed Apr. 18, 2024, which is assigned to the assignee hereof, and which is expressly incorporated by reference in its entirety herein.

### TECHNICAL FIELD

The following relates to one or more systems for memory, including security for read commands.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports security for read commands in accordance with examples as disclosed herein.

FIG. 2 shows an example of a flow diagram that supports security for read commands in accordance with examples as disclosed herein.

FIG. 3 shows an example of a secure read protect configuration block that supports security for read commands in accordance with examples as disclosed herein.

FIG. 4 shows an example of a secure read protect entry that supports security for read commands in accordance with examples as disclosed herein.

FIG. 5 shows a block diagram of a Memory System that supports security for read commands in accordance with examples as disclosed herein.

FIGS. 6 and 7 show flowcharts illustrating a method or methods that support security for read commands in accordance with examples as disclosed herein.

### DETAILED DESCRIPTION

The memory system may provide access to a replay protected memory block (RPMB). The RPMB may be formed of one or more logical units, and the contents of the RPMB logical unit may be read or written via an authenticated read and write accesses, respectively. The RPMB logical unit may be configured into multiple RPMB regions where each RPMB region includes at least an authentication key, a counter, a register, and logical address. In some cases, each RPMB region may process a single RPMB authenticated operation. The memory system may store data to the specific memory area in an authenticated and replay protected manner (e.g., RPMB authenticated operation). In some cases, the memory system may store authentication key information in the memory device to secure the communication of commands for the access operations (e.g., read operation, write operation, and the like). The authentication key may be utilized to sign the requests and responses for reads and writes made to the replay protected memory area. The memory system may include two RPMB modes for securing accessing the memory device. The first RPMB mode may be an example of an advanced RPMB mode, and the second RPMB mode may be an example of a normal RPMB mode.

However, in some systems, the memory system may be unable to verify whether a read request is issued from an authenticated host system in the first RMPB mode. In the second mode, in some systems, the memory system may be unable to provide any level of security for read requests and/or read responses associated with read operations. In such cases, the memory system may be unable to provide protection against replay of messages, thereby increasing the risk of issues experienced by the memory system and decreasing the efficiency of the memory system. Decreased security in the RPMB modes may increase the risk of hacking and other compromises to the system as a whole, which may have a variety of consequences including theft of information from the system, failure of various sub-systems of the system, increasing the power consumption, and decreasing the start-up time of performing operations (e.g., a lag time for application start-up). For example, messages may be recorded and replayed by an attacker (e.g., hacker), which may decrease the overall performance of the memory system and increase a quantity of complications associated with the memory system. Such cases may pose a threat to the security and safety of the memory system.

Systems, devices, and techniques are described to improve security and safety of the memory system, thereby improving the overall efficiency and operations of the memory system. In some memory systems, techniques for verifying whether the read request is issued by the authenticated host system in the first RPMB mode are disclosed. Techniques for implementing a level of security and/or protection in the second RPMB mode are further disclosed. By authenticating the read request, the memory system may be able to read data and transmit the data to the host system in a secure, protected environment, thereby improving the reliability and security of the memory system.

In the first RPMB mode, the memory system may receive, from the host system, a read command (e.g., read request) to read data from the RPMB region. The read command may include the message authenticated code (MAC) key. The memory system may authenticate the read command using the MAC key and retrieve the data from the RPMB region. The memory system may transmit the data after authenticating the read command and retrieving the data.

In the second RPMB mode, the memory system may receive, from the host system, the read command (e.g., read request) to read data from the RPMB region. The memory system may determine whether a read protect flag associated with a logical unit identified by the read command indicates that reading of data stored in the logical unit is permitted. The memory system may read the data in response to determining that the read protect flag permits reading the data. In such cases, authenticating the read command may increase the reliability and security of the memory system, thereby allowing the memory system or other components to perform operations at improved speeds, efficiency, and performance.

Features of the disclosure are illustrated and described in the context of systems, devices, and circuits. Features of the disclosure are further illustrated and described in the context of a flow diagram, configuration block, and entry and flowcharts.

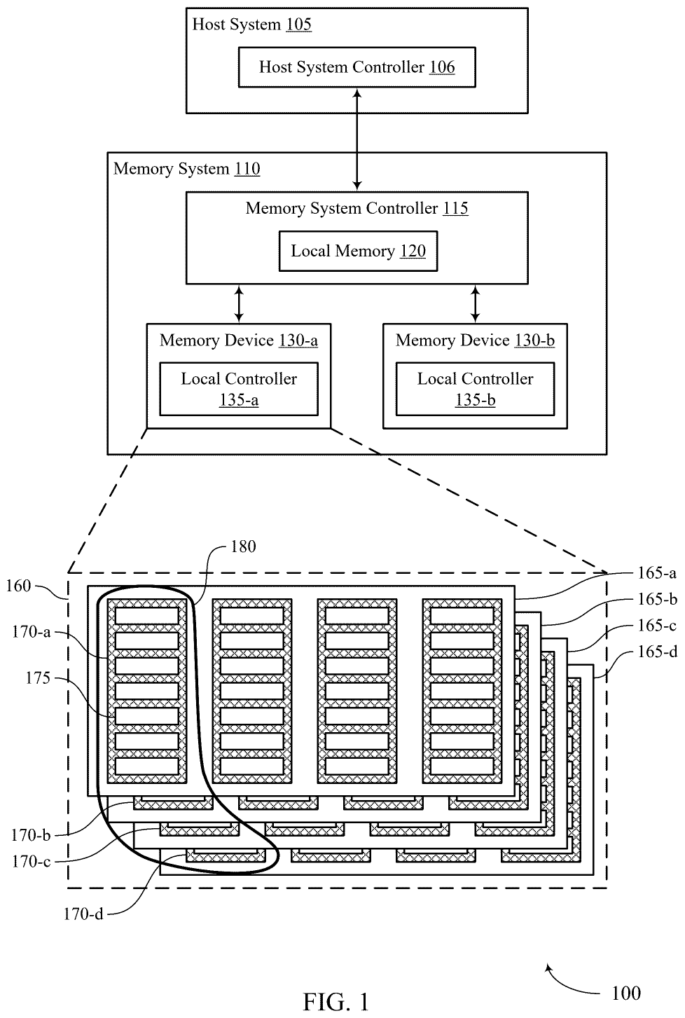

FIG. 1 shows an example of a system 100 that supports security for read commands in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some examples, the memory system 110 may receive a read command, from the host system 105, to read data from the RPMB region. In some cases, the read command may include the MAC key. The memory system 110 may authenticate the read command using the MAC key and retrieve the data from the RPMB region based on (e.g., in response to) authenticating the command. For example, the data may be read from the address indicated in the request (e.g., the read command). The memory system 110 may transmit, to the host system 105, the data after retrieving the data from the RPMB region. In some cases, in response to receiving the read command, the memory system 110 may determine whether a read protect flag associated with a logical unit identified by the read command indicates that reading of data stored in the logical unit is permitted. In such cases, the memory system may read the data based at least in part on determining that the read protect flag permits reading the data.

In some examples, the memory system 110 may determine whether a read counter included in the read command has expired in response to receiving the read command. In response to determining that the read counter is valid, the memory system 110 may authenticate the read command using the MAC key. In such cases, if the MAC key and read counter are valid, then the read request is authenticated. By authenticating the read command using the MAC key and read counter, the memory system 110 may experience increased security and an increased efficiency in preventing future errors.

In addition to applicability in memory systems described herein, techniques for security for read commands may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by improving the security for read commands, and may prevent or mitigate unauthorized access to data or other information, incur lower latency costs (e.g., by implementing it at hardware level), use less power relative to other solutions, among other benefits.

The system 100 may include any quantity of non-transitory computer readable media that support security for read commands. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

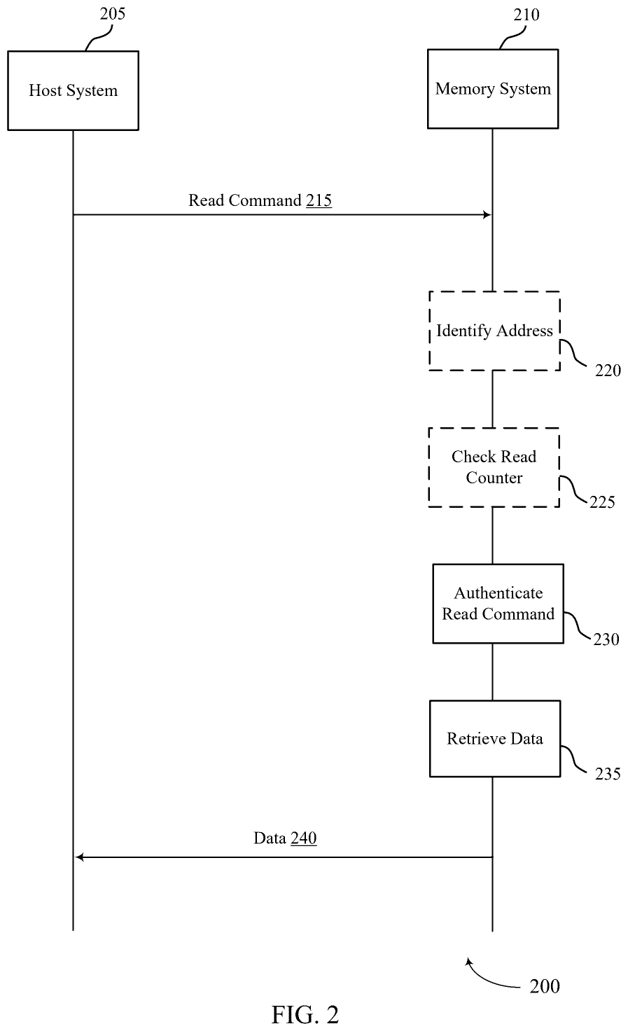

FIG. 2 shows an example of a flow diagram 200 that supports security for read commands in accordance with examples as disclosed herein. Flow diagram 200 may include host system 205 and memory system 210, which may be respective examples of a host system 105 and memory system 110 as described in reference to FIG. 1. The steps performed by the host system 205 in flow diagram 200 may be implemented in instructions stored on memory of host system 105 and executed by the host system controller 106. The steps performed by the memory system 210 in flow diagram 200 may be implemented in instructions stored on memory of memory system 110 (e.g., memory device 130) and executed by the memory system controller 115 (and/or local controller 135).

Alternative examples of the following may be implemented, where some steps are performed in a different order or not at all. Some steps may additionally include additional features not mentioned below. The flow diagram 200 illustrates techniques for the first RMPB mode where a host system 205 communicates an authenticated data read to the memory system 210, which may be examples of the first RPMB mode.

Aspects of the flow diagram 200 may be implemented by one or more controllers, among other components. Additionally, or alternatively, aspects of the flow diagram 200 may be implemented as instructions stored in one or more memories (e.g., firmware stored in one or more memories coupled with the memory system 210). For example, the instructions, when executed by one or more controllers (e.g., the memory system controller 115), may cause the one or more controllers (or a device or system) to perform the operations of the flow diagram 200.

In some other systems, the RPMB read operation in the first RPMB mode may include a minimal level of security protocols where the memory system may be unable to verify whether the RPMB logical unit read request is issued from an authenticated host system. In such cases, the efficiency of the memory system may decrease and a quantity of issues that may remain unaddressed or unnoticed may increase, thereby decreasing the overall performance of the memory system and increasing a quantity of hardware and software complications associated with the memory system. Performing read operations without verifying whether the RPMB logical unit read request is issued from an authenticated host system may increase the risk of hacking and other compromises to the system as a whole, which may have a variety of consequences including theft of information from the system, failure of various sub-systems of the system, increasing the power consumption, decreasing the efficiency and start-up time of performing operations (e.g., a lag time for application start-up), and decreasing the overall performance of the memory system.

Systems, devices, and techniques are described to increase the security and safety of the memory system, thereby improving the overall efficiency and operations of the memory system, by providing an interface for the host system 205 to configure a customized security mode. For example, the RPMB logical unit may be configured individually such that the host system 205 may fill in the read count and MAC field in the RPMB authenticated data read request (e.g., the RPMB logical unit read request). In such cases, read access to specified LBA ranges may be protected, thereby improving the security and safety of the memory system, and allowing the memory system or other components to perform operations at improved speeds, efficiency, and performance.

At 215, a read command may be transmitted. For example, the host system 205 may transmit a read command to the memory system 210. The memory system 210 may receive the read command to read data from a read protected memory block (RPMB) region. The read command may include a MAC key (e.g., a first MAC key). In some examples, the host system 205 may send the security protocol out command (e.g., the read command) with security protocol field set to “ECh” and indicating the RPMB region in the security protocol specific field. The RPMB data frame may include the request message type, the nonce, the data address, read counter, the MAC/key, and the block count. The read command may be an example of a read request, security protocol out command, RPMB logical unit read request, RPMB authenticated data read request, and the like. The read command may include contents identified in TABLE 1.

TABLE 1

| Field Name | Value | |
|---|---|---|
| Stuff bytes | 0 . . . 00 | h |
| MAC/Key | First MAC key | |
| Data | 0 . . . 0 | h |
| Nonce | Nonce from host system 205 | |
| Read counter | Current counter value | |
| Address | Address | |
| Block Count | Number of 256B blocks | |
| Result | 0000 | h |
| Req./Resp. | 0004 | h |

At 220, an address may be identified. For example, the memory system 210 may determine whether an address included in the read command is within the RPMB region after receiving the read command. In some examples, if the device (e.g., memory system 210) receives the request (e.g., the read command), the device checks the address. The memory system 210 may output an indication that the address is invalid in response to determining that the address is outside of the RPMB region. For example, if the address value is equal to or greater than the size of target RPMB region, then the result (e.g., a field called result in the read response) may be set to “address failure,” and the data read is not valid. For example, the result code that is the value of the result field is set to “address failure.” In other examples, if the address value plus the block count value is greater than the size of target RPMB region, then the result is set to “address failure,” and no data is read from the RPMB data area (e.g., RPMB region). In such cases, the value of the result field (e.g., the result code) is set to “address failure.”

At 225, a read counter may be checked. For example, the memory system 210 may determine whether a read counter included in the read command has expired in response to receiving the read command. In some examples, if the device (e.g., the memory system 210) receives the RPMB message, the device may check whether the read counter has expired. The RPMB message may be an example of a command UFS Protocol Information Unit (UPIU). The memory system 210 may output an indication that the read counter has expired after determining that the read counter has expired. For example, if the read counter is expired, then the memory system sets the result (e.g., a field called result in the read response) to “read failure, read counter expired,” and no data is read from the RPMB data area. For example, the result code that is the value of the result field is set to “read failure, read counter expired.”

At 230, the read command may be authenticated. For example, the memory system 210 may authenticate the read command using the MAC key. The read command may be authenticated in response to receiving the read command that includes the MAC key. In some cases, authenticating the read command using the MAC key may be in response to determining that the address is within the RPMB region. In some examples, authenticating the read command using the MAC key is performed after determining that the read counter is valid.

In some examples, authenticating the read command may include determining a second MAC key using a request type, a block counter, the read counter, an address, the data, or any combination thereof. The memory system 210 may determine whether the MAC key included in the read command and the second MAC key are equal after (e.g., in response to) determining the second MAC key. For example, if the read counter was not expired, then the device may calculate the MAC (e.g., the second MAC key) of request type, block count, read counter, address and data, and then compare (e.g., including at least the second MAC key) the result with the MAC key in the request (e.g., included in the read command). The memory system 210 may output an indication that the MAC key included in the read command (e.g., the first MAC key) is different than the second MAC key in direct response to determining that the first MAC key is different than the second MAC key. If the two MAC keys are different, then the memory system 210 sets the result to “authentication failure,” and no data is read from the RPMB region in response to determining that the first MAC key is different than the second MAC key. In such cases, the value of the result field (e.g., the result code) is set to “authentication failure.”

In some cases, the memory system 210 may authenticate the read command by comparing a first read counter included in the read command with a second read counter stored by the memory system 210. The memory system 210 may compare the first read counter with the second read counter after using the first MAC key. In some cases, the memory system 210 may determine whether the first read counter and the second read counter are equal after comparing the first read counter with the second read counter.

For example, if the MAC in the request (e.g., the first MAC key) and the calculated MAC (e.g., the second MAC key) are equal, then the memory system 210 compares the first read counter in the request with the second read counter stored in the memory system 210. If the two counters are different, then the memory system 210 sets the result to “counter failure,” and no data is read from the RPMB data area. In such cases, the value of the result field (e.g., the result code) is set to “counter failure.” The memory system 210 may output an indication that a first read counter is different than a second read counter in response to comparing the first read counter with the second read counter. If the MAC and read counter comparisons are successful (e.g., the MAC keys are equal and the read counter are equal), then the read request is authenticated, and the data is read from the address indicated in the request. In such cases, in order to authenticate the read request, the first MAC key is equal to the second MAC key, and the first read counter is equal to the second read counter.

At 235, data is retrieved. For example, the memory system 210 may retrieve the data from the RPMB region in response to authenticating the read command. The memory system 210 may increment a read counter stored by the memory system 210 after retrieving the data from the RPMB region. For example, the read counter is incremented by one if the read operation is successfully executed (e.g., is completed without one or more errors).

At 240, data may be transmitted. For example, the memory system 210 may transmit the data to the host system 205. The memory system 210 may transmit the data after retrieving the data from the RPMB region. In some cases, transmitting the data may include transmitting an RPMB message including a block count, a copy of a nonce received in the read command, an address received in the read command, the data, or the first MAC key, or any combination thereof. For example, the memory system may transmit the RPMB message with a response message type, the block count, the counter value (incremented by one if the read operation is executed), the copy of the nonce received in the request (e.g., the read command), the address received in the authenticated data read request (e.g., the read command), the data, the MAC (e.g., the first MAC key) and the result of the authenticated data read operation. The RPMB message may be an example of a response UPIU.

The nonce may include a copy of the received nonce, the address may be an example of a starting address of the full access (i.e., not the address of the individual logical block), and the block count may be an example of the total count of the blocks (i.e., not the sequence number of blocks). For example, the block count may be an example of a quantity of block rather than a sequence number of each individual block within the sequence. In each data frame, the read counter indicates the current counter value. In some examples, transmitting the data includes transmitting an indication of a second MAC field of the memory system 210. For example, the MAC is included in the last RPMB message data frame. The MAC field may be set to the first MAC key in all previous data frames. The read response (e.g., the data) may include the contents as identified in TABLE 2.

TABLE 2

| Field Name | Value | |
|---|---|---|
| Stuff bytes | 0 . . . 00 | h |
| MAC/Key | First MAC key | |
| Data | Data | |
| Nonce | Copy of the nonce | |
| Read counter | New counter value | |
| Address | Address | |
| Block Count | Number of 256B blocks | |
| Result | Result code | |
| Req./Resp. | 0004 | h |

By provide a higher level of security for the data read in the first RPMB mode, the memory system 210 may improve error management, reduce test firmware releases to detect error conditions, and allow a safe state (e.g., safe mode of operation) for the host system 205 to communicate with the memory system 210. In such cases, increasing the security of the first RPMB mode may enable the memory system 210 to quickly address issues, improve latency in error handling, and prevent future errors from occurring.

In some cases, a vendor specific attribute may be used for a customized security mode configuration. The attribute may be an example of parameter that represents a specific range of numeric values that can be written or read. The attribute may be stored in a mode register of the memory system. Based on the value set in the description of the attribute, the memory system may operate in one of a plurality of data read protection modes. The vendor specific attribute may include the contents as identified in TABLE 3.

TABLE 3

| | | | | Type | | |
|---|---|---|---|---|---|---|
| | | Access | | #Ind. | | |
| IDN | Name | Property | Size | #Sel. | Default | Description |
| xxh | bDataRead- | Read/Write | 1 | D | 0 | 00 h |
| | ProtectionMode | once | byte | | | 01 h |
| | | | | | | 02 h |
| | | | | | | 03 h |

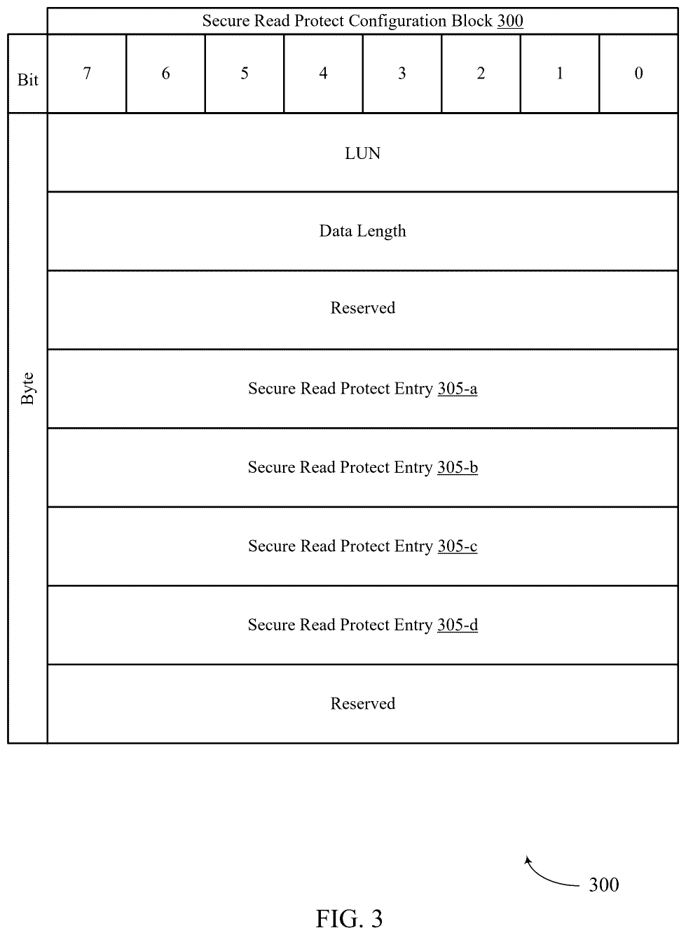

In such cases, the description of the attribute may signal, to the memory system, which data read protection mode to operate in. The description may include at least four different data read protection modes to operation in. For example, a description of the attribute set to “00h” may indicate operating the memory system in a first mode including a legacy operation mode of the first RPMB mode and a legacy operation mode of the second RPMB mode. In such cases, the value of the description field is set to “00h.” The legacy operation mode of the first RPMB mode may be an example of a minimal level of security protocols where the memory system may be unable to verify whether the RPMB logical unit read request is issued from an authenticated host system, as described herein. The legacy operation mode of the second RPMB mode may be an example of a logical unit read operation without any security protocols, as described with reference to FIG. 3.

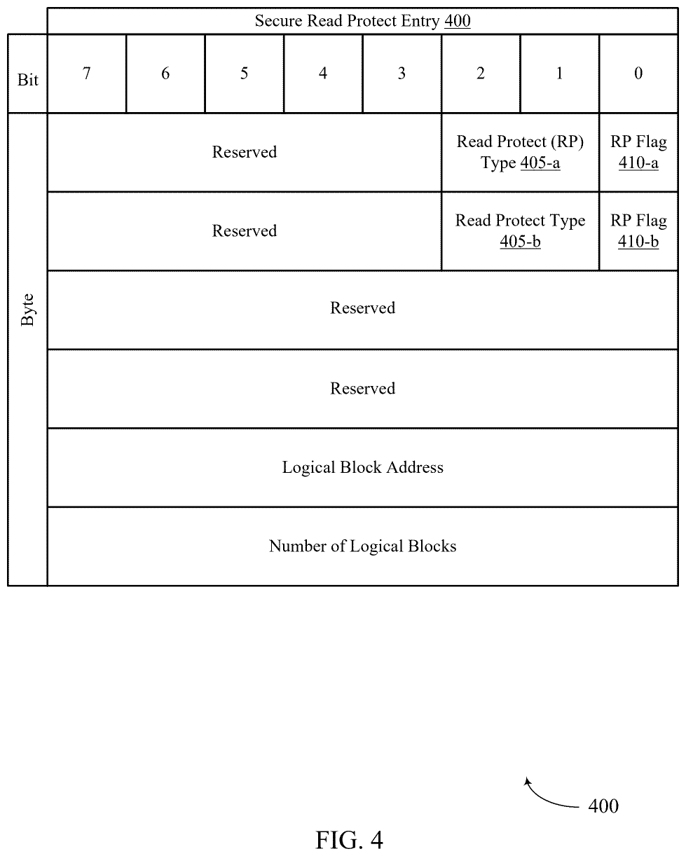

A description of the attribute set to “01h” may indicate operating the memory system in a second mode including the legacy operation mode of the first RPMB mode and the second RPMB mode, as described with reference to FIGS. 3 and 4. In such cases, the value of the description field is set to “01h.” A description of the attribute set to “02h” may indicate operating the memory system in a third mode including the first RPMB mode, as described with reference to FIG. 2, and the legacy operation mode of the second RPMB mode. In such cases, the value of the description field is set to “02h.” A description of the attribute set to “03h” may indicate operating the memory system in a fourth mode including the first RPMB mode and the second RPMB mode. The value of the description field is set to “03h.” In such cases, value of the description field set to “01h” and “03h,” may indicate to the memory system to operate in the second RPMB mode, as described with reference to FIGS. 3 and 4.

FIG. 3 shows an example of a secure read protect configuration block 300 that supports security for read commands in accordance with examples as disclosed herein. The secure read protect configuration block 300 may include a LUN, data length, reserved bits, and a plurality of secure read protect entries 305. The steps performed by the memory system may be implemented in instructions stored on memory of memory system 110 (e.g., memory device 130) and executed by the memory system controller 115 (and/or local controller 135).

In some systems, the logical unit read operation (e.g., the second RPMB mode) may not include any security protocols, which decreases the efficiency of the memory system and increases a quantity of issues that may remain unaddressed, thereby decreasing the overall performance of the memory system and increasing a quantity of hardware and software complications associated with the memory system. Performing logical unit read operations without security or authentication of the read commands and/or responses may increase the risk of hacking and other compromises to the system as a whole, which may have a variety of consequences including theft of information from the system, decreasing the efficiency and start-up time of performing operations (e.g., a lag time for application start-up), and decreasing the overall performance of the memory system.

Systems, devices, and techniques are described to improve security and safety of the memory system using the second RPMB mode by adding a read protect type and read protect flag in the RPMB secure read protect entry 305 of the secure read protect configuration block 300, as described with reference to FIGS. 3 and 4. In such cases, read access to specified LBA ranges may be protected, thereby improving the security and safety of the memory system, and allowing the memory system or other components to perform operations at improved speeds, efficiency, and performance.

The second RPMB mode may be an example of another technique to secure read requests and read responses as compared to the first RPMB mode as described with reference to FIG. 2. In some cases, the second RPMB mode may be used in combination with the first RPMB mode, as described with reference to TABLE 3. In other examples, the second RPMB mode and the first RPMB mode may be used interchangeably to secure read requests and read responses. The second RPMB mode, as described herein with reference to FIGS. 3 and 4, may be used with the logical unit read operation.

In some examples, the memory system may include a single secure read protect configuration block 300 for each logical unit. The secure read protect configuration block 300 may include 256 bytes. In some cases, the secure read protect configuration block 300 may be supported by the RPMB region. The secure read protect configuration block 300 may be used for configuring secure read protect areas in logical units.

The secure read protect configuration block 300 may include up to four secure read protect entries 305. For example, the secure read protect configuration block 300 may include a first secure read protect entry 305-a, a second secure read protect entry 305-b, a third secure read protect entry 305-c, and a fourth secure read protect entry 305-d. Each entry of the plurality of secure read protect entries 305 represents a secure read protect area.

In some cases, the secure read protect configuration block 300 may include the first secure read protect entry 305-a, the first secure read protect entry 305-a and the second secure read protect entry 305-b, the first secure read protect entry 305-a, the second secure read protect entry 305-b, and the third secure read protect entry 305-c, or all four secure read protect entries 305. If an entry 305 is not used, then the related fields may contain a value of zero.

The secure read protect configuration block 300 may include a LUN field. The LUN field may indicate the logical unit to which secure read protection may apply. The secure read protect configuration block 300 may include a data length field. The data length field may specify the length in bytes of the secure read protect entries 305 (e.g., 0 for no entry, 16 for one entry, 32 for two entries, 48 for three entries, and 64 for four entries).

In some cases, the host system may issue, to one or more regions of the memory system, an authenticated secure read protect configuration block 300 for a read operation. For example, the host system may issue, to the RPMB region of the memory system, an authenticated secure read protect configuration block 300 for a read operation. In such cases, the memory system may receive a read command to read data from RPMB region. In some examples, the read sequence for the authenticated secure read protect configuration block 300 may be initiated by a security protocol out command (e.g., as described with reference to FIG. 2).

The security protocol out command may include a single RPMB message data frame that contains the secure read protect configuration block 300 in the data field. The secure read protect configuration block 300 is specific to the logical unit indicated by the LUN field. If the memory system receives the RPMB message data frame, the memory system may check whether the read counter has expired. If the read counter is expired, then the memory system sets the result to “read failure, read counter expired,” and the secure read protect configuration block 300 is not updated. In such cases, the value of the result field (e.g., the result code) is set to “read failure, read counter expired.”

As described with reference to FIG. 2, if the read counter is not expired, then the memory system calculates the MAC of request type, block count, read counter, address and data, and compares the calculated MAC with the MAC in the request (e.g., the read command). If the two MACs are different, then the memory system may set the result to “authentication failure,” and the secure read protect configuration block 300 is not updated. For example, the value of the result field (e.g., the result code) is set to “authentication failure.”

In some cases, if the MAC in the request and the calculated MAC are equal, then the memory system compares the read counter in the request with the read counter stored in the memory system. If the two counters are different, then the memory system sets the result to “counter failure,” and the secure read protect configuration block 300 is not updated. In such cases, the value of the result field (e.g., the result code) is set to “counter failure.” Alternatively, if the MAC and read counter comparisons are successful (e.g., each of the MAC comparison and read counter comparison, respectively, are equal), then the read request is considered to be authenticated, and the secure read protect configuration block 300 is updated.

FIG. 4 shows an example of a secure read protect entry 400 that supports security for read commands in accordance with examples as disclosed herein. The secure read protect entry 400 may be an example of a secure read protect entry of the secure read protection configuration block, as described with reference to FIG. 3. The secure read protect entry 400 may include reserved bits, a logical block address, a plurality of logical blocks, read protect types 405, and read protect flags 410. The steps performed by the memory system may be implemented in instructions stored on memory of memory system 110 (e.g., memory device 130) and executed by the memory system controller 115 (and/or local controller 135).

The memory system may receive a read command to read data from RPMB region. The memory system may determine whether a read protect flag 410 associated with a logical unit identified by the read command indicates that reading of data stored in the logical unit is permitted. The memory system may read the data directly in response to determining that the read protect flag 410 permits reading the data. In such cases, the memory system may transmit the data in response to reading the data. For example, the memory system may return, to the host system, the RPMB data frame containing the response message type.

In some cases, the memory system may receive a first message to set the read protect flag 410 of the logical unit to a first value that indicates that reading of the data stored in the logical unit is allowed. In some examples, the read command may be received after receiving a first message to set the read protect flag 410 to the first value. For example, a bit of the read protect flag 410 may be set to zero (e.g., the first value) to specify that the logical unit may allow writing to the medium. In some cases, the memory system may receive a second message to set the read protect flag 410 of the logical unit to a second value that indicates that reading of the data stored in the logical unit is not allowed. For example, a bit of the read protect flag 410 may be set to one (e.g., the second value) to specify that the logical unit may inhibit alteration of the medium for LBAs within the range indicated by logical block address field of the secure read protect entry 400 and the number (e.g., quantity) of logical blocks field of the secure read protect entry 400.

In some cases, the memory system may determine a value of the read protect flag 410 after performing a power cycle or a hardware reset of the memory system based at least in part on a read protect type 405 of the logical unit. In some examples, a bit of the read protect flag 410 is automatically cleared to 0b (or 1b) after the power cycle or hardware reset. In other examples, the read protect flag 410 may be persistent (e.g., maintained) through the power cycle and hardware reset. In such cases, the value of the read protect flag 410 may be changed by writing to the secure read protect configuration block. The read protect type 405 may be included in a configuration block associated with the logical unit. In some examples, the field of the read protect type 405 may specify how the bit of the read protect flag 410 may be modified.

The memory system may update a configuration block (e.g., the secure read protect configuration block) associated with the logical unit to include the first value of the read protect flag 410 after receiving the message to set the read protect flag 410 of the logical unit to the first value. In such cases, the read command may be received after updating the configuration block. In some examples, if no error occurred, then the secure read protect configuration block is updated, thereby overwriting the former configuration. The read counter may be incremented by one after the secure read protect configuration block is updated. For example, the memory system may increment a counter in response to updating the configuration block.

The secure read protect entry 400 may include a logical block address field. The logical block address field may specify the LBA of the first logical block of the secure read protect area. The secure read protect entry 400 may also include a number of logical blocks field. The number of logical blocks field may specify the number (e.g., quantity) of contiguous logical blocks that belong to the secure read protect area. If the number of logical blocks field is set to zero, then the secure read protection may apply to the entire logical unit. In such cases, the first secure read protect entry 400, as described with reference to FIG. 3, may be configured to enable secure read protection for the entire logical unit.

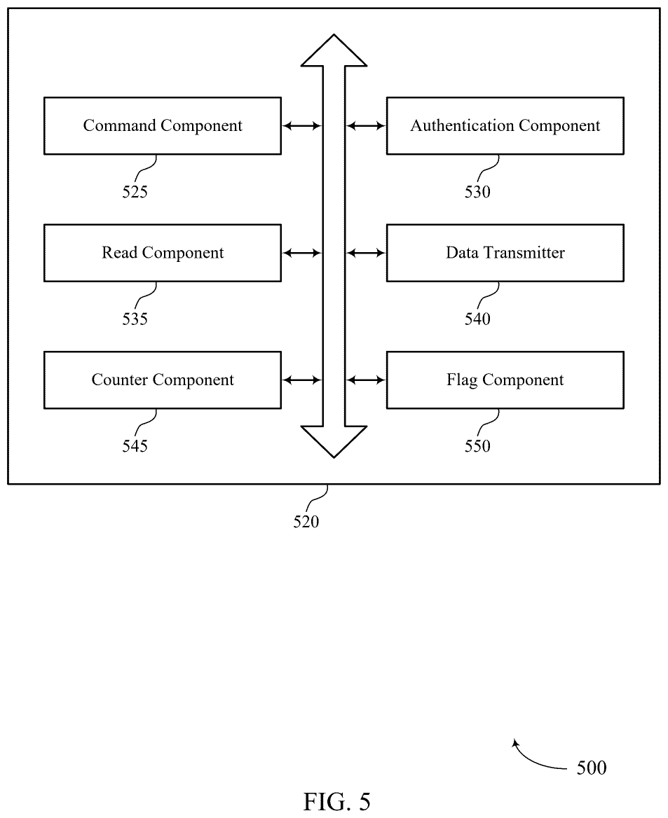

FIG. 5 shows a block diagram 500 of a memory system 520 that supports security for read commands in accordance with examples as disclosed herein. The memory system 520 may be an example of aspects of a memory system as described with reference to FIGS. 1 through 4. The memory system 520, or various components thereof, may be an example of means for performing various aspects of security for read commands as described herein. For example, the memory system 520 may include a command component 525, an authentication component 530, a read component 535, a data transmitter 540, a counter component 545, a flag component 550, or any combination thereof. Each of these components, or components of subcomponents thereof (e.g., one or more processors, one or more memories), may communicate, directly or indirectly, with one another (e.g., via one or more buses).

The command component 525 may be configured as or otherwise support a means for receiving a read command to read data from a RPMB region, the read command including a first MAC key. The authentication component 530 may be configured as or otherwise support a means for authenticating the read command using the first MAC key. The read component 535 may be configured as or otherwise support a means for retrieving the data from the RPMB region based at least in part on authenticating the read command. The data transmitter 540 may be configured as or otherwise support a means for transmitting the data based at least in part on retrieving the data from the RPMB region.

In some examples, the counter component 545 may be configured as or otherwise support a means for determining whether a read counter included in the read command has expired based at least in part on receiving the read command, where authenticating the read command using the first MAC key is based at least in part on determining that the read counter is valid.

In some examples, the counter component 545 may be configured as or otherwise support a means for outputting an indication that the read counter has expired based at least in part on determining that the read counter has expired.

In some examples, to support authenticating the read command, the authentication component 530 may be configured as or otherwise support a means for determining a second MAC key using a request type, a block counter, the read counter, an address, or the data, or any combination thereof. In some examples, to support authenticating the read command, the authentication component 530 may be configured as or otherwise support a means for determining whether the first MAC key included in the read command and the second MAC key are equal based at least in part on determining the second MAC key.

In some examples, the authentication component 530 may be configured as or otherwise support a means for outputting an indication that the first MAC key is different than the second MAC key based at least in part on determining that the first MAC key is different than the second MAC key.

In some examples, the command component 525 may be configured as or otherwise support a means for determining whether an address included in the read command is within the RPMB region based at least in part on receiving the read command, where authenticating the read command using the first MAC key is based at least in part on determining that the address is within the RPMB region.

In some examples, the command component 525 may be configured as or otherwise support a means for outputting an indication that the address is invalid based at least in part on determining that the address is outside of the RPMB region.

In some examples, to support authenticating the read command, the authentication component 530 may be configured as or otherwise support a means for comparing a first read counter included in the read command with a second read counter stored by the memory system after using the first MAC key. In some examples, to support authenticating the read command, the authentication component 530 may be configured as or otherwise support a means for determining whether the first read counter and the second read counter are equal based at least in part on comparing the first read counter with the second read counter.

In some examples, the counter component 545 may be configured as or otherwise support a means for outputting an indication that a first read counter is different than a second read counter based at least in part on comparing the first read counter with the second read counter.

In some examples, the counter component 545 may be configured as or otherwise support a means for incrementing a read counter stored by the memory system based at least in part on retrieving the data from the RPMB region, where transmitting the data includes transmitting an indication of the read counter that has been incremented.

In some examples, to support transmitting the data, the data transmitter 540 may be configured as or otherwise support a means for transmitting an RPMB message including a block count, a copy of a nonce received in the read command, an address received in the read command, the data, or the first MAC key, or any combination thereof.

In some examples, to support transmitting the data, the data transmitter 540 may be configured as or otherwise support a means for transmitting an indication of a second MAC field of the memory system.

In some examples, the command component 525 may be configured as or otherwise support a means for receiving a read command to read data from a RPMB region. In some examples, the authentication component 530 may be configured as or otherwise support a means for determining whether a read protect flag associated with a logical unit identified by the read command indicates that reading of data stored in the logical unit is permitted. In some examples, the read component 535 may be configured as or otherwise support a means for reading the data based at least in part on determining that the read protect flag permits reading the data.

In some examples, the data transmitter 540 may be configured as or otherwise support a means for transmitting the data based at least in part on reading the data.

In some examples, the flag component 550 may be configured as or otherwise support a means for receiving a first message to set the read protect flag of the logical unit to a first value that indicates that reading of the data stored in the logical unit is allowed, where receiving the read command occurs after receiving the first message.

In some examples, the flag component 550 may be configured as or otherwise support a means for receiving a second message to set the read protect flag of the logical unit to a second value that indicates that reading of the data stored in the logical unit not allowed after transmitting the data.

In some examples, the flag component 550 may be configured as or otherwise support a means for updating a configuration block associated with the logical unit to include the first value of the read protect flag based at least in part on receiving the first message, where receiving the read command occurs after updating the configuration block.

In some examples, the configuration block includes a plurality of secure read protect entries. In some examples, each entry of the plurality of secure read protect entries represents a secure read protect area.

In some examples, the counter component 545 may be configured as or otherwise support a means for incrementing a counter based at least in part on updating the configuration block.

In some examples, the configuration block includes a secure read protect configuration block.

In some examples, the flag component 550 may be configured as or otherwise support a means for determining a value of the read protect flag after performing a power cycle or a hardware reset of the memory system based at least in part on a read protect type of the logical unit.

In some examples, the read protect type is included in a configuration block associated with the logical unit.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

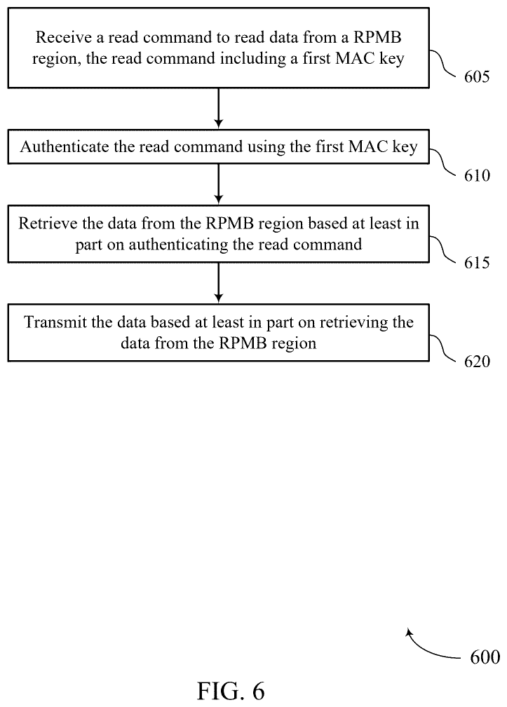

FIG. 6 shows a flowchart illustrating a method 600 that supports security for read commands in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving a read command to read data from a RPMB region, the read command including a first MAC key. In some examples, aspects of the operations of 605 may be performed by a command component 525 as described with reference to FIG. 5.

At 610, the method may include authenticating the read command using the first MAC key. In some examples, aspects of the operations of 610 may be performed by an authentication component 530 as described with reference to FIG. 5.

At 615, the method may include retrieving the data from the RPMB region based at least in part on authenticating the read command; and. In some examples, aspects of the operations of 615 may be performed by a read component 535 as described with reference to FIG. 5.

At 620, the method may include transmitting the data based at least in part on retrieving the data from the RPMB region. In some examples, aspects of the operations of 620 may be performed by a data transmitter 540 as described with reference to FIG. 5.

In some examples, an apparatus as described herein may perform a method or methods, such as the method 600. The apparatus may include operations, features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a read command to read data from a RPMB region, the read command including a first MAC key; authenticating the read command using the first MAC key; retrieving the data from the RPMB region based at least in part on authenticating the read command; and transmitting the data based at least in part on retrieving the data from the RPMB region.

Aspect 2: The method, apparatus, or non-transitory computer-readable medium of aspect 1, further including operations, features, circuitry, logic, means, or instructions, or any combination thereof for determining whether a read counter included in the read command has expired based at least in part on receiving the read command, where authenticating the read command using the first MAC key is based at least in part on determining that the read counter is valid.

Aspect 3: The method, apparatus, or non-transitory computer-readable medium of aspect 2, further including operations, features, circuitry, logic, means, or instructions, or any combination thereof for outputting an indication that the read counter has expired based at least in part on determining that the read counter has expired.

Aspect 4: The method, apparatus, or non-transitory computer-readable medium of any of aspects 2 through 3, where authenticating the read command further includes operations, features, circuitry, logic, means, or instructions, or any combination thereof for determining a second MAC key using a request type, a block counter, the read counter, an address, or the data, or any combination thereof and determining whether the first MAC key included in the read command and the second MAC key are equal based at least in part on determining the second MAC key.

Aspect 5: The method, apparatus, or non-transitory computer-readable medium of aspect 4, further including operations, features, circuitry, logic, means, or instructions, or any combination thereof for outputting an indication that the first MAC key is different than the second MAC key based at least in part on determining that the first MAC key is different than the second MAC key.

Aspect 6: The method, apparatus, or non-transitory computer-readable medium of any of aspects 1 through 5, further including operations, features, circuitry, logic, means, or instructions, or any combination thereof for determining whether an address included in the read command is within the RPMB region based at least in part on receiving the read command, where authenticating the read command using the first MAC key is based at least in part on determining that the address is within the RPMB region.

Aspect 7: The method, apparatus, or non-transitory computer-readable medium of aspect 6, further including operations, features, circuitry, logic, means, or instructions, or any combination thereof for outputting an indication that the address is invalid based at least in part on determining that the address is outside of the RPMB region.

Aspect 8: The method, apparatus, or non-transitory computer-readable medium of any of aspects 1 through 7, where authenticating the read command further includes operations, features, circuitry, logic, means, or instructions, or any combination thereof for comparing a first read counter included in the read command with a second read counter stored by the memory system after using the first MAC key and determining whether the first read counter and the second read counter are equal based at least in part on comparing the first read counter with the second read counter.

Aspect 9: The method, apparatus, or non-transitory computer-readable medium of any of aspects 1 through 8, further including operations, features, circuitry, logic, means, or instructions, or any combination thereof for outputting an indication that a first read counter is different than a second read counter based at least in part on comparing the first read counter with the second read counter.

Aspect 10: The method, apparatus, or non-transitory computer-readable medium of any of aspects 1 through 9, further including operations, features, circuitry, logic, means, or instructions, or any combination thereof for incrementing a read counter stored by the memory system based at least in part on retrieving the data from the RPMB region, where transmitting the data includes transmitting an indication of the read counter that has been incremented.

Aspect 11: The method, apparatus, or non-transitory computer-readable medium of any of aspects 1 through 10, where transmitting the data further includes operations, features, circuitry, logic, means, or instructions, or any combination thereof for transmitting an RPMB message including a block count, a copy of a nonce received in the read command, an address received in the read command, the data, or the first MAC key, or any combination thereof.

Aspect 12: The method, apparatus, or non-transitory computer-readable medium of any of aspects 1 through 11, where transmitting the data further includes operations, features, circuitry, logic, means, or instructions, or any combination thereof for transmitting an indication of a second MAC field of the memory system.

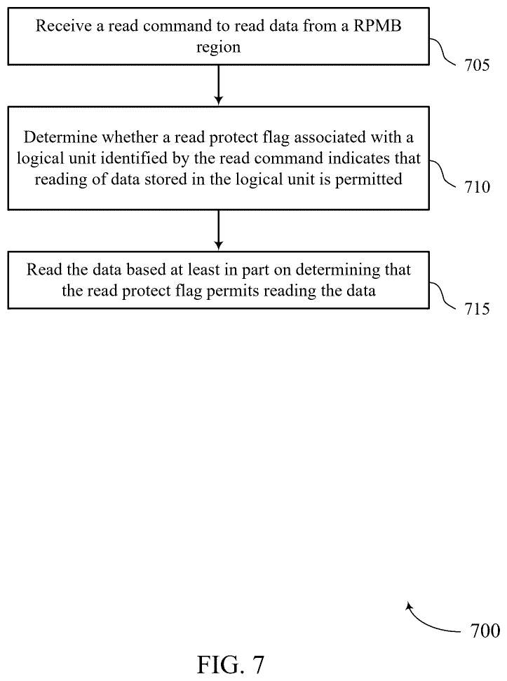

FIG. 7 shows a flowchart illustrating a method 700 that supports security for read commands in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include receiving a read command to read data from a RPMB region. In some examples, aspects of the operations of 705 may be performed by a command component 525 as described with reference to FIG. 5.

At 710, the method may include determining whether a read protect flag associated with a logical unit identified by the read command indicates that reading of data stored in the logical unit is permitted; and. In some examples, aspects of the operations of 710 may be performed by an authentication component 530 as described with reference to FIG. 5.

At 715, the method may include reading the data based at least in part on determining that the read protect flag permits reading the data. In some examples, aspects of the operations of 715 may be performed by a read component 535 as described with reference to FIG. 5.

In some examples, an apparatus as described herein may perform a method or methods, such as the method 700. The apparatus may include operations, features, circuitry, logic, means, or instructions (e.g., a non-transitory computer-readable medium storing instructions executable by a processor), or any combination thereof for performing the following aspects of the present disclosure:

Aspect 13: A method, apparatus, or non-transitory computer-readable medium including operations, features, circuitry, logic, means, or instructions, or any combination thereof for receiving a read command to read data from a RPMB region; determining whether a read protect flag associated with a logical unit identified by the read command indicates that reading of data stored in the logical unit is permitted; and reading the data based at least in part on determining that the read protect flag permits reading the data.

Aspect 14: The method, apparatus, or non-transitory computer-readable medium of aspect 13, further including operations, features, circuitry, logic, means, or instructions, or any combination thereof for transmitting the data based at least in part on reading the data.

Aspect 15: The method, apparatus, or non-transitory computer-readable medium of any of aspects 13 through 14, further including operations, features, circuitry, logic, means, or instructions, or any combination thereof for receiving a first message to set the read protect flag of the logical unit to a first value that indicates that reading of the data stored in the logical unit is allowed, where receiving the read command occurs after receiving the first message.

Aspect 16: The method, apparatus, or non-transitory computer-readable medium of aspect 15, further including operations, features, circuitry, logic, means, or instructions, or any combination thereof for receiving a second message to set the read protect flag of the logical unit to a second value that indicates that reading of the data stored in the logical unit not allowed after transmitting the data.

Aspect 17: The method, apparatus, or non-transitory computer-readable medium of any of aspects 15 through 16, further including operations, features, circuitry, logic, means, or instructions, or any combination thereof for updating a configuration block associated with the logical unit to include the first value of the read protect flag based at least in part on receiving the first message, where receiving the read command occurs after updating the configuration block.

Aspect 18: The method, apparatus, or non-transitory computer-readable medium of aspect 17, where the configuration block includes a plurality of secure read protect entries and each entry of the plurality of secure read protect entries represents a secure read protect area.

Aspect 19: The method, apparatus, or non-transitory computer-readable medium of any of aspects 17 through 18, further including operations, features, circuitry, logic, means, or instructions, or any combination thereof for incrementing a counter based at least in part on updating the configuration block.

Aspect 20: The method, apparatus, or non-transitory computer-readable medium of any of aspects 17 through 19, where the configuration block includes a secure read protect configuration block.

Aspect 21: The method, apparatus, or non-transitory computer-readable medium of any of aspects 13 through 20, further including operations, features, circuitry, logic, means, or instructions, or any combination thereof for determining a value of the read protect flag after performing a power cycle or a hardware reset of the memory system based at least in part on a read protect type of the logical unit.

Aspect 22: The method, apparatus, or non-transitory computer-readable medium of aspect 21, where the read protect type is included in a configuration block associated with the logical unit.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a read command to read data from a read protected memory block (RPMB) region, the read command comprising a first message authenticated code (MAC) key;
authenticate the read command using the first MAC key;
retrieve the data from the RPMB region based at least in part on authenticating the read command; and
transmit the data based at least in part on retrieving the data from the RPMB region.

2. The memory system of claim 1, wherein the processing circuitry is further configured to cause the memory system to:
determine whether a read counter included in the read command has expired based at least in part on receiving the read command, wherein authenticating the read command using the first MAC key is based at least in part on determining that the read counter is valid.

3. The memory system of claim 2, wherein the processing circuitry is further configured to cause the memory system to:
output an indication that the read counter has expired based at least in part on determining that the read counter has expired.

4. The memory system of claim 2, wherein authenticating the read command further comprises the processing circuitry configured to cause the memory system to:
determine a second MAC key using a request type, a block counter, the read counter, an address, or the data, or any combination thereof; and
determine whether the first MAC key included in the read command and the second MAC key are equal based at least in part on determining the second MAC key.

5. The memory system of claim 4, wherein the processing circuitry is further configured to cause the memory system to:
output an indication that the first MAC key is different than the second MAC key based at least in part on determining that the first MAC key is different than the second MAC key.

6. The memory system of claim 1, wherein the processing circuitry is further configured to cause the memory system to:
determine whether an address included in the read command is within the RPMB region based at least in part on receiving the read command, wherein authenticating the read command using the first MAC key is based at least in part on determining that the address is within the RPMB region.

7. The memory system of claim 6, wherein the processing circuitry is further configured to cause the memory system to:
output an indication that the address is invalid based at least in part on determining that the address is outside of the RPMB region.

8. The memory system of claim 1, wherein authenticating the read command further comprises the processing circuitry configured to cause the memory system to:
compare a first read counter included in the read command with a second read counter stored by the memory system after using the first MAC key; and
determine whether the first read counter and the second read counter are equal based at least in part on comparing the first read counter with the second read counter.

9. The memory system of claim 1, wherein the processing circuitry is further configured to cause the memory system to:
output an indication that a first read counter is different than a second read counter based at least in part on comparing the first read counter with the second read counter.

10. The memory system of claim 1, wherein the processing circuitry is further configured to cause the memory system to:
increment a read counter stored by the memory system based at least in part on retrieving the data from the RPMB region, wherein transmitting the data includes transmitting an indication of the read counter that has been incremented.

11. The memory system of claim 1, wherein transmitting the data further comprises the processing circuitry configured to cause the memory system to:
transmit an RPMB message comprising a block count, a copy of a nonce received in the read command, an address received in the read command, the data, or the first MAC key, or any combination thereof.

12. The memory system of claim 1, wherein transmitting the data further comprises the processing circuitry configured to cause the memory system to:
transmit an indication of a second MAC field of the memory system.

13. A memory system, comprising:
one or more memory devices; and
processing circuitry coupled with the one or more memory devices and configured to cause the memory system to:
receive a read command to read data from a read protected memory block (RPMB) region;
determine whether a read protect flag associated with a logical unit identified by the read command indicates that reading of data stored in the logical unit is permitted; and
read the data based at least in part on determining that the read protect flag permits reading the data.

14. The memory system of claim 13, wherein the processing circuitry is further configured to cause the memory system to:
transmit the data based at least in part on reading the data.

15. The memory system of claim 13, wherein the processing circuitry is further configured to cause the memory system to:
receive a first message to set the read protect flag of the logical unit to a first value that indicates that reading of the data stored in the logical unit is allowed, wherein receiving the read command occurs after receiving the first message.

16. The memory system of claim 15, wherein the processing circuitry is further configured to cause the memory system to:
receive a second message to set the read protect flag of the logical unit to a second value that indicates that reading of the data stored in the logical unit not allowed after transmitting the data.

17. The memory system of claim 15, wherein the processing circuitry is further configured to cause the memory system to:
update a configuration block associated with the logical unit to include the first value of the read protect flag based at least in part on receiving the first message, wherein receiving the read command occurs after updating the configuration block.

18. The memory system of claim 17, wherein the configuration block comprises a plurality of secure read protect entries, wherein each entry of the plurality of secure read protect entries represents a secure read protect area.

19. The memory system of claim 17, wherein the processing circuitry is further configured to cause the memory system to:
increment a counter based at least in part on updating the configuration block.

20. The memory system of claim 17, wherein the configuration block comprises a secure read protect configuration block.

21. The memory system of claim 13, wherein the processing circuitry is further configured to cause the memory system to:
determine a value of the read protect flag after performing a power cycle or a hardware reset of the memory system based at least in part on a read protect type of the logical unit.

22. The memory system of claim 21, wherein the read protect type is included in a configuration block associated with the logical unit.

23. A non-transitory computer-readable medium storing code comprising instructions which, when executed by processing circuitry of an electronic device, cause the electronic device to:
receive a read command to read data from a read protected memory block (RPMB) region, the read command comprising a first message authenticated code (MAC) key;
authenticate the read command using the first MAC key;
retrieve the data from the RPMB region based at least in part on authenticating the read command; and
transmit the data based at least in part on retrieving the data from the RPMB region.

24. The non-transitory computer-readable medium of claim 23, wherein the instructions are further executable by the processing circuitry to:
determine whether a read counter included in the read command has expired based at least in part on receiving the read command, wherein authenticating the read command using the first MAC key is based at least in part on determining that the read counter is valid.

25. The non-transitory computer-readable medium of claim 24, wherein the instructions are further executable by the processing circuitry to:
output an indication that the read counter has expired based at least in part on determining that the read counter has expired.
